(19) United States
(12) Patent Application Publication
(10) Pub. No.: US 2026/0203839 A1
(43) Pub. Date: Jul. 16, 2026

(54) SYSTEMS AND METHODS FOR GENERATING AN OUTFIT RECOMMENDATION

(71) Applicant: PRONTI AI INC., Kitchener (CA)

(72) Inventor: Mila BANERJEE, Puslinch (CA)

(21) Appl. No.: 19/441,033

(22) Filed: Jan. 6, 2026

Related U.S. Application Data
(60) Provisional application No. 63/743,808, filed on Jan. 10, 2025.

(51) Int. Cl. G06Q 50/10; G06Q 10/109

(52) U.S. Cl. CPC G06Q 50/10; G06Q 10/109

(57) ABSTRACT

Various systems and methods for generating an outfit recommendation including outfit wearable items for a user are described herein. The systems and methods disclosed herein can involve retrieving, from a data storage, user closet data identifying user wearable items associated with the user, receiving, over a network, an input from a user device associated with the user identifying a target style profile, retrieving from the data storage, annotated clothing data associated with one or more other users satisfying the target style profile, identifying one or more clothing features from the annotated clothing data correlated with the target style profile and generate a generic outfit profile comprising the one or more clothing features and determining the outfit recommendation for the user using at least the user closet data, based on the generic outfit profile. The outfit recommendation includes one or more recommended outfit wearable items.

### CROSS-REFERENCE TO RELATED APPLICATION(S)

This application claims the benefit of U.S. Provisional Patent Application No. 63/743,808 filed Jan. 10, 2025 entitled “SYSTEMS AND METHODS FOR GENERATING AN OUTFIT RECOMMENDATION”. The contents of U.S. Provisional Patent Application No. 63/743,808 is hereby incorporated herein by reference in its entirety.

### FIELD

The described embodiments generally relate to outfit recommendation systems for generating an outfit recommendation for a user, and methods of operating thereof.

### BACKGROUND

For many individuals, choosing outfits is a time-consuming activity that can sometimes become an unpleasant chore, due to various reasons, including poor styling skills, lack of interest, and/or lack of inspiration. Even for individuals who enjoy fashion and style, outfit selection can quickly become unwieldy, particularly for individuals having large closets, since keeping an inventory of their wearable items can be difficult. It is estimated that over the course of a year, 80% of the items in a typical person's closet go unworn.

Existing systems include fashion inspiration websites that allow users to create outfits by manually creating collages of wearable items to generate individual outfits that can be shared. However, these websites are typically difficult to navigate and searched if the user does use the right keywords, or if the user does not already know what they are looking for. Additionally, outfits created by other users often include wearable items that the user does not already own, requiring the user to make substitutions or to purchase new clothing items, which can become costly. When making substitutions, it can also sometimes be difficult to determine whether a substituted clothing item is equally suitable. Social media websites are also often used for fashion inspiration. Social media websites allow outfits to be shared more easily though they can be more difficult to search than conventional fashion inspiration websites and can focus on aspirational wearable items that are outside the budget range of many.

### SUMMARY

The various embodiments described herein generally relate to outfit recommendation systems for generating an outfit recommendation for a user, and methods of operating thereof.

In accordance with an example embodiment, there is provided a method for generating an outfit recommendation including outfit wearable items for a user. The method involves operating a processor to: retrieve, from a data storage, user closet data identifying user wearable items associated with the user; receive, over a network, an input from a user device associated with the user identifying a target style profile; retrieve, from the data storage, annotated clothing data associated with one or more other users satisfying the target style profile; identify one or more clothing features from the annotated clothing data correlated with the target style profile and generate a generic outfit profile comprising the one or more clothing features; and determine the outfit recommendation for the user using at least the user closet data, based on the generic outfit profile, the outfit recommendation including one or more recommended outfit wearable items.

In some embodiments, the target style profile comprises a target location and the method comprises operating the processor to: generate the generic outfit profile for the target location.

In some embodiments, the target style profile comprises a target profession and the method comprises operating the processor to: generate the generic outfit profile for the target profession.

In some embodiments, the target style profile further comprises one or more of: a target season and target weather and the method further comprises operating the processor to: automatically adapt the generic outfit profile according to the target season and/or the target weather.

In some embodiments, the input comprises a calendar and the target season and/or the target weather is determined based at least in part on the calendar.

In some embodiments, the input comprises a calendar and the method further comprises operating the processor to: identify an event for the user based on the calendar; and determine the outfit recommendation for the user based on the event.

In some embodiments, annotations of the annotated clothing data relate to one or more of: a mood, an occasion and one or more clothing item categories.

In some embodiments, the method further comprises operating the processor to: determine a style profile for the user based at least on the user closet data; and determine the outfit recommendation for the user based on the style profile for the user.

In some embodiments, the method further comprises operating the processor to receive from the user device, feedback for the outfit recommendation; and update the style profile for the user based on the feedback.

In some embodiments, the method further comprises operating the processor to: determine if the one or more recommended outfit wearable items are present in the user closet data; and in response to determining that one or more recommended outfit wearable items are not associated with the user closet data, identify one or more retailer wearable items as the one or more recommended outfit wearable items, the one or more retailer wearable items associated with one or more retailers.

In some embodiments, the method further comprises operating the processor to: select one or more recommended retailers based on the style profile for the user, wherein the one or more retailer wearable items are associated with the one or more recommended retailers.

In some embodiments, the method further comprises operating the processor to: select one or more recommended retailers from a group of promoted retailers, wherein the one or more retailer wearable items are associated with the one or more recommended retailers.

In some embodiments, one or more of the one or more other users comprises retail users.

In some embodiments, the target style profile comprises a target entity and the annotated clothing data is obtained by processing one or more images of the target entity to identify wearable items worn by the target entity in the one or more images.

In accordance with an embodiment, there is provided a system for generating an outfit recommendation including outfit wearable items for a user. The system includes: a data storage storing: user closet data identifying user wearable items associated with the user; annotated clothing data associated with one or more other users; and a processor operable to: retrieve, from the data storage, the user closet data; receive, over a network, an input from a user device associated with the user identifying a target style profile; retrieve, from the data storage, annotated clothing data satisfying the target style profile; identify one or more clothing features from the annotated clothing data correlated with the target style profile and generate a generic outfit profile comprising the one or more clothing features; and determine the outfit recommendation for the user using at least the user closet data, based on the generic outfit profile, the outfit recommendation including one or more recommended outfit wearable items.

In some embodiments, the target style profile comprises a target location and the processor is further operable to: generate the generic outfit profile for the target location.

In some embodiments the target style profile comprises a target profession and the processor is further operable to: generate the generic outfit profile for the target profession.

In some embodiments the target style profile further comprises one or more of: a target season and target weather and the processor is further operable to: automatically adapt the generic outfit profile according to the target season and/or the target weather.

In some embodiments, the input comprises a calendar and the target season and/or the target weather is determined based at least in part on the calendar.

In some embodiments, the input comprises a calendar and the processor is further operable to: identify an event for the user based on the calendar; and determine the outfit recommendation for the user based on the event.

In some embodiments, annotations of the annotated clothing data relate to one or more of: a mood, an occasion and a clothing item category.

In some embodiments the processor is further operable to: determine a style profile for the user based at least on the user closet data; and determine the outfit recommendation for the user based on the style profile for the user.

In some embodiments, the processor is further operable to: receive from the user device, feedback for the outfit recommendation; and update the style profile for the user based on the feedback.

In some embodiments, the processor is further operable to: determine if the one or more recommended outfit wearable items are present in the user closet data; and in response to determining that one or more recommended outfit wearable items are not associated with the user closet data, identify one or more retailer wearable items as the one or more recommended outfit wearable items, the one or more retailer wearable items associated with one or more retailers.

In some embodiments the processor is further operable to: select one or more recommended retailers based on the style profile for the user, wherein the one or more retailer wearable items are associated with the one or more recommended retailers.

In some embodiments, the processor is operable to: select one or more recommended retailers from a group of promoted retailers, wherein the one or more retailer wearable items are associated with the one or more recommended retailers.

In some embodiments, one or more of the one or more other users comprises retail users.

In some embodiments, the target style profile comprises a target entity and the annotated clothing data is obtained by processing one or more images of the target entity to identify wearable items worn by the target entity in the one or more images.

### BRIEF DESCRIPTION OF THE DRAWINGS

Several embodiments will be described in detail with reference to the drawings, in which:

FIG. 1 is a block diagram of an example outfit recommendation system in communication with external components, in accordance with an example embodiment;

FIG. 2 is a flowchart of a method for determining outfit recommendations for a user in accordance with an example embodiment;

FIG. 3 shows a graphical user interface (GUI) illustrating an example embodiment of an application of the outfit recommendation system described herein;

FIG. 4 shows a graphical user interface illustrating another example embodiment of an application of the outfit recommendation system described herein;

FIG. 5 shows a graphical user interface illustrating an example embodiment of an application of the outfit recommendation system described herein;

FIG. 6 shows a graphical user interface illustrating another example embodiment of an application of the outfit recommendation system described herein;

FIG. 7 shows a graphical user interface illustrating an example embodiment of an application of the outfit recommendation system described herein; and

FIG. 8 shows a graphical user interface illustrating an example embodiment of an application of the outfit recommendation system described herein.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

The various embodiments described herein generally relate to outfit recommendation systems for generating an outfit recommendation for a user, and methods of operating the systems.

Choosing what clothes to wear is an essential part of most people's day. For some individuals, outfit selection can be a fun activity, a hobby or even a job. For example, social media has enabled some individuals to earn a living from offering styling advice. For many individuals however, choosing an outfit is nothing more than a necessity and, in some cases, can even be a dreadful, daily occurrence. For most individuals, outfit selection is time-consuming, especially when seeking to avoid repeating outfits. For individuals who own a large number of wearable items, keeping track of wearable items can also be difficult and time-consuming, and can often cause some wearable items to be underused or forgotten. In many cases, unused and underused items are discarded and since they are seldom recycled, end up in landfills.

Fashion inspiration websites have displaced fashion magazines as the primary source of inspiration for many fashion-minded individuals. These websites typically allow users to browse libraries of wearable items or copy images of wearable items from retailer websites (e.g., clothing store websites) to create outfits that can then be shared publicly. These websites can allow users to find inspiration to assemble outfits that can be worn in daily life, making them more appealing than fashion magazines.

However, these websites are typically difficult to navigate, and their search functionalities can be subpar, requiring users creating outfits to use search tags and users searching for outfits to use the same search tags as search terms. Given the variety of search terms and tags that may be used, these systems can be difficult to use. These websites can also be overwhelming for users who may not be familiar with fashion or styling terms, or who may not know what to search for.

Additionally, when viewing outfits created by other users, a user is unlikely to find outfits that include wearable items the user already owns. Though some users may be able to make substitutions, many users are unable to identify adequate substitutions. Users who are unable to make substitutions often resort to purchasing the wearable items or abandon these websites.

There are tools that users can use to generate outfits using items they have included within their virtual closet (which are likely items they own or considering to purchase) but these tools are often very limited in scope For example, such tools can typically only generate generic recommendations, based on preset rules for matching wearable items within that user's virtual closet - that is, no external inspiration in any way. In addition, these solutions typically only provide a limited number of outfit recommendations since they rely on a pre-programmed, static engine for recommending outfits.

The systems and methods disclosed herein generate outfit recommendations for a user based on wearable items that are within the user's virtual closet (e.g., owned, that can be borrowed by the user, or likely of interest) and data from other users, via style profiles. As used herein, an outfit includes at least two wearable items and unless stated otherwise, wearable items include any item that can be worn on a person's body, including accessories.

By generating outfit recommendations using data from external sources (e.g., individuals who may be users or sources of inspirations and/or companies that are marketing the items), the outfit recommendations can dynamically evolve, including evolve with trends, as more data about other users is received rather than relying on static, default style profiles. In addition, by using data from other users, the systems and methods disclosed herein can enable outfits to be generated using data from the outfit recommendation system's own databases, without the need for external styling data.

The systems and methods disclosed herein can use data from other users by identifying users that satisfy a target style profile specified by the user seeking an outfit recommendation, retrieving annotated clothing data associated with those users and identifying clothing features from the annotated clothing data that are correlated with the target style profile. By identifying these clothing features, a generic outfit profile that includes these clothing features can be generated and an outfit recommendation that is based on the generic outfit profile can be generated.

As will be described in further detail below, in some embodiments, the systems and methods disclosed herein can enable a user to obtain outfit recommendations so that the user can mimic the style of others, such as, but not limited to living at a particular location, someone exercising a particular profession and/or like a particular celebrity. The described systems and methods can identify other users living in the selected location and/or exercising the selected profession to generate similar outfits using at least some of the user's wearable items within the virtual closet.

In some embodiments, the outfit recommendations can be adapted according to other factors, such as, but not limited to, the weather and/or the season and/or driven by the user's calendar. For example, events in the user's calendar can be used to generate outfit recommendations.

In some embodiments, the outfit recommendations can be adapted according to the user's style profile. The outfit recommendations systems disclosed herein can determine a style profile for each user based on information about the user including the user's virtual closet data. By employing the user's style profile, the outfit recommendations generated can be tailored to the user's style preferences. In some embodiments, feedback received regarding outfit recommendations, outfits worn by the user and/or outfits created by the user, including the frequency at which certain wearable items are worn, can be used to update the user's style profile so that future outfit recommendations can be more aligned with the user's style preferences.

In some embodiments, the outfit recommendations can include items that are not in the user's possession but that may be purchased from retailers. By allowing retailer wearable items to be recommended, the outfit recommendation systems and methods disclosed herein can provide a broader range of outfit recommendations and can enable retailers to advertise on or sponsor the outfit recommendation systems disclosed herein. The outfit recommendation system can also adapt the percentage of the outfit that uses items not currently within the user's virtual closet—that is, the outfit recommendation system can determine that the user is feeling more adventurous and would like to have a broader recommendation of new items to complement only a handful of items within the virtual closet, or the outfit recommendation system can determine that the user is not eager to expand the virtual closet and offer only very minor items to complement items within the virtual closet. The outfit recommendation system can adapt the scope of recommendation based on specified user preference and/or other factors, such as online browsing history, recent and/or upcoming calendar entries, recent outfit selections as provided to the outfit recommendation system, and/or feedback received from the user on recent outfit recommendations.

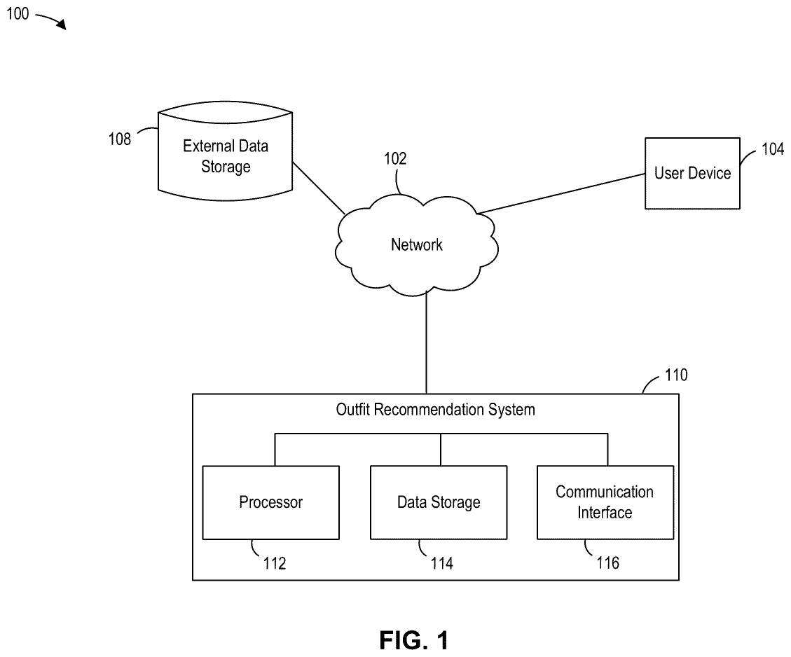

Reference is now made to FIG. 1, which shows a block diagram 100 of an example outfit recommendation system 110 in communication with a user device 104 and an external data storage 108 via a network 102. For illustration purposes, only one user device 104 is illustrated in FIG. 1. It is understood that more than one user device 104 can be used with the outfit recommendation system 110 disclosed herein. The outfit recommendation system 110 can communicate with the user device 104 and the external data storage 108 over a wide geographic area via the network 102.

The outfit recommendation system 110 includes a processor 112, a data storage 114 and a communication interface 116. The outfit recommendation system 110 can be implemented with more than one computer server distributed over a wide geographic area and connected via the network 102. The processor 112, the data storage 114 and the communication interface 116 may be combined into fewer components or may be separated into further components. The outfit recommendation system 110 can include other components, in some embodiments. The outfit recommendation system 110 can employ machine learning techniques to generate outfit recommendations.

The processor 112 can be implemented with any suitable processor, controller, digital signal processor, graphics processing unit, application specific integrated circuits (ASICs), and/or field programmable gate arrays (FPGAs) that can provide sufficient processing power for the configuration, purposes and requirements of the outfit recommendation system 110. The processor 112 can include more than one processor and each processor can be configured to perform different dedicated tasks.

The communication interface 116 can include any interface that enables the outfit recommendation system 110 to communicate with various devices and other systems. For example, the communication interface 116 can receive input data from a user device 104 or data from the external data storage 108 and process the data and/or receive input data from the user device 104 and store the data in the data storage 114 or the external data storage 108. The communication interface 116 may also include at least one of an Internet, Local Area Network (LAN), Ethernet, Firewire, modem or digital subscriber line connection. Various combinations of these elements may be incorporated within the communication interface 116.

The data storage 114 can include RAM, ROM, one or more hard drives, one or more flash drives or some other suitable data storage elements such as disk drives, etc. The data storage 114 can, for example, include a memory unit used to store programs and an operating system used by the outfit recommendation system 110. For instance, the operating system provides various basic operational processes for the operator unit. The programs include various user programs so that a user can interact with the outfit recommendation system 110, but not limited to, viewing and manipulating data as well.

The data storage 114 may further include one or more databases (not shown in FIG. 1) for storing information related to, for example users; wearable items, including images of wearable items, annotated clothing data; outfits including outfit recommendations; and style profiles, including target style profiles, generic outfit profiles, etc. The information can be stored on one database or separated into multiple databases. The data storage 114 may also store data models that define the relationships between different data sets and models for processing images of wearable items. The information and data models may be stored also in the external data storage 108 as a backup storage solution, or some portions of the information and data models may be stored remotely in the external data storage 108 and accessed by the outfit recommendation system 110 as needed.

The data storage 114 can store information about the user, including, but limited to, general information about the user that may typically be stored in a user profile, including personal information (e.g., name, contact information, gender), information about the user's personal characteristics (e.g., gender presentation, clothing size, profession, location, etc.), and a login identifier and password for accessing the outfit recommendation system 110. For example, during an onboarding phase, the outfit recommendation system 110 may request information from the user to generate a user profile. The data storage 114 may also store user preferences (e.g., style profiles, clothing retailers, outfits, wearable items, budget, etc.) in the user profile. In some embodiments, the user profile is generated based in part on the user's answers to questions posed by the outfit recommendation system 110. Example questions include but are not limited to, the user's age, whether the user would like to keep their style or change their style, the user's weight, whether the user prefers a classic style or a bold style, whether the user prefers to follow traditional fashion rules or follow their own rules, whether the user prefers neutrals or colors, the user's gender presentation, etc. In some embodiments, the questions can be answered using a sliding scale. The data storage 114 may also store user closet data identifying user wearable items in association with the user profile. The user of the outfit recommendation system 110 may be an individual seeking outfit recommendations.

The data storage 114 can store user closet data identifying wearable items in the user's possession, including wearable items owned by a user or wearable items that are otherwise in the user's possession (e.g., shared wearable items, wearable items the user can borrow) in association with the user profiles. In some embodiments, the user closet data is encoded as a collection of tensors that characterize features wearable items in the user's possession. During an onboarding phase, the user can identify wearable items that are in the user's possession to create a virtual closet by capturing and uploading and/or selecting from the user device's 104 image gallery and uploading, using the user device 104, images of wearable items to the outfit recommendation system 110 (e.g., a server of the outfit recommendation system 110). The user can upload one image at a time or multiple images at a time. The images can be images of the wearable items alone (e.g., on a hanger, on a flat surface) and/or images of the user, including selfies, or another person wearing the wearable items. In at least one embodiment, the outfit recommendation system 110 can employ image processing techniques as are known to those skilled in the art of image processing to extract the wearable items from the images. For example, the outfit recommendation system 110 can use image segmentation techniques and/or object detection techniques to remove backgrounds from images of wearable items. The outfit recommendation system 110 can also use image transformation techniques to scale and/or improve the image sizes and/or quality. In some embodiments, the user device associated with the user can perform at least some of the image processing tasks and the user device can transmit to the outfit recommendation system 110 processed images of wearable items. The process can be repeated after the onboarding phase, each time the user desires to add a clothing item.

Alternatively, or in addition thereto, in at least one embodiment, the user can provide hyperlinks of webpages showing the wearable items (e.g., a link to a clothing retailer's website) and/or search the web for wearable items and the outfit recommendation system 110 can extract images of the wearable items from the webpage. The extracted images of the wearable items can be stored in the data storage 114. In at least one embodiment, the user can upload ecommerce purchase confirmations from the user's email inbox and the outfit recommendation system 110 can retrieve images of the wearable items from the ecommerce retailer's website.

Alternatively, or in addition thereto, in at least one embodiment, during the onboarding stage, the outfit recommendation system 110 can generate a sample closet that includes commonly owned wearable items. For example, the outfit recommendation system 110 can present images of commonly owned wearable items and the outfit recommendation system 110 can receive a selection from the user device 104 of wearable items that are in the user's possession and/or that the user would like to add to the user's virtual closet. The images of the selected wearable items can be stored in the data storage 114.

Alternatively, or in addition thereto, in at least one embodiment, the outfit recommendation system 110 can present images of recommended wearable items based on the user preferences stored in the user profile and can receive a selection from the user device 104 of wearable items that are in the user's possession. Images of the selected wearable items can be stored in the data storage 114.

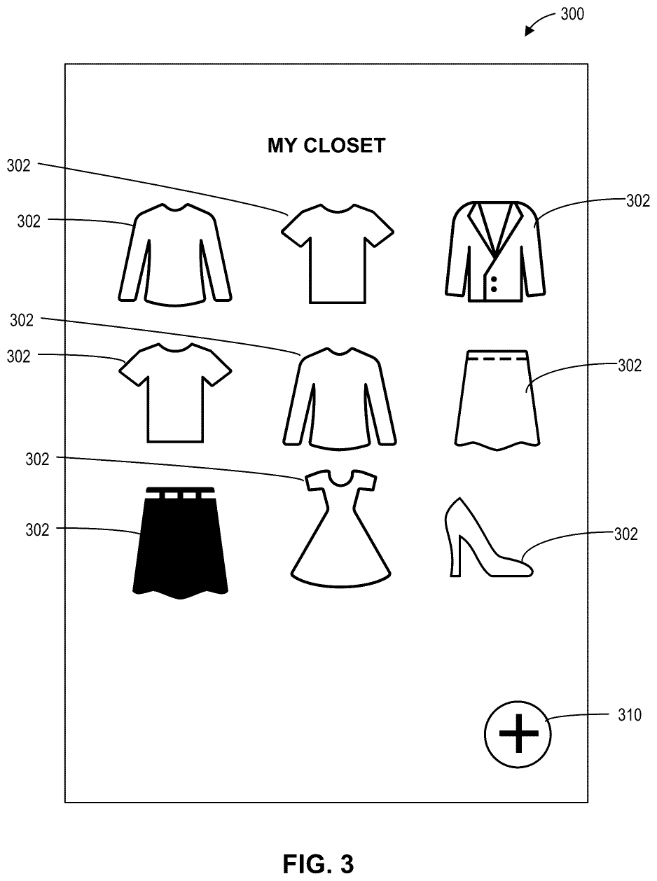

Referring briefly to FIG. 3, which shows a screenshot 300 of a GUI of an application of the outfit recommendation system 110, wearable items 302 added to the user's virtual closet can be displayed, allowing the user to view the user's wearable items. As shown, the user can interact with the GUI via a GUI element such as button 310 to add wearable items.

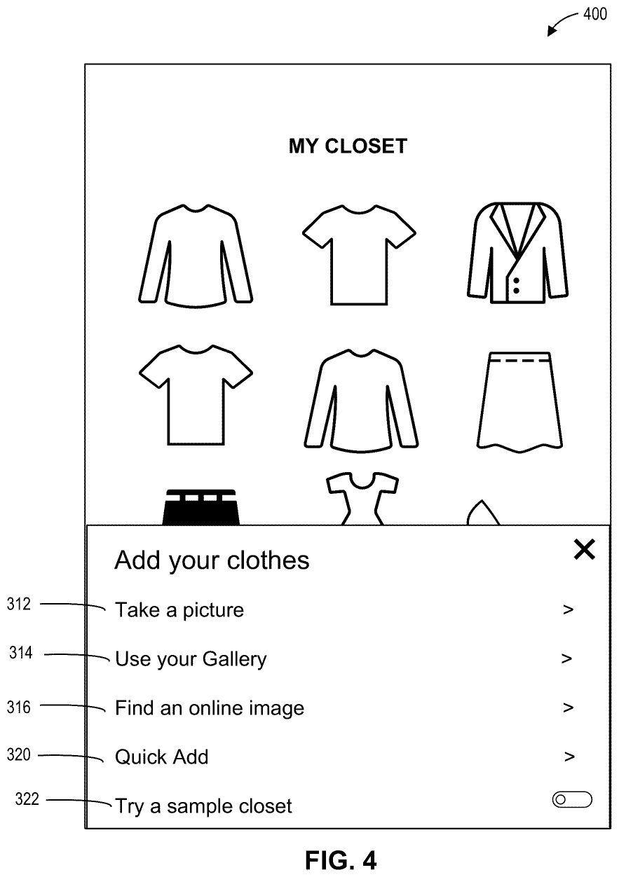

Referring briefly to FIG. 4, which shows a screenshot 400 of a GUI of an application of the outfit recommendation system 110, as shown the user can interact with the GUI to add wearable items. In the example shown in FIG. 4, different options (take a picture 312, use your gallery 314, find an online image 316, quick add 320, try a sample closet 322) for adding wearable items can be implemented as interactable GUI elements. The quick add option 320 can enable the user to add multiple wearable items to the user's virtual closet by, for example, uploading ecommerce purchase confirmations from the user's email inbox, uploading multiple images, importing a virtual closet from an external system, etc.

The data storage 114 can store annotated clothing data. Annotated clothing data can include wearable items that have been assigned one or more tags by a user and/or by the outfit recommendation system 110. For example, the one or more tags can include a mood (e.g., festive, cozy, comfortable, glamorous, etc.), an occasion (e.g., brunch date, networking event, bridal shower, garden party, etc.), a weather or season. The mood and/or occasion may be a default mood and/or occasion, or a custom mood and/or occasion assigned by a user. By allowing the user to assign moods and/or occasions, the outfit recommendation system 110 can generate outfit recommendations that are specific to the user's interpretation of the moods and/or occasions. For example, a first user may assign the occasion “day drinking” to loungewear while a second user may assign a mini skirt and sparkly shoes to the occasion “day drinking”. By enabling users to assign wearable items to occasions and/or moods, the outfit recommendation system 110 may recommend outfit recommendations that are consistent with the user's interpretation of an occasion and/or a mood, rather than with a generic interpretation.

The one or more tags can also include categories and sub-categories (e.g., characteristics) associated with the wearable items as determined by the outfit recommendation system 110. An example white blouse may be assigned, for example, the tags “white”, “top”, “puff sleeves” “V-neck”, “long sleeves” “blouse”. At least some of the categories may be determined by processing an image of the wearable item. For example, the outfit recommendation system 110 can employ visual semantic embeddings techniques and tensor-based techniques for assessing the images and determining the content of the images and image classification techniques for assigning tags to the wearable items. In some embodiments, the outfit recommendation system 110 generates a tensor representation of each wearable item and/or of the user's virtual closet. In some embodiments, the one or more tags include a brand of the wearable item. In some embodiments, the user device associated with the user can process the images of the wearable items and assign tags to the wearable items. In such embodiments, the outfit recommendation system 110 can receive, from the user device, annotated clothing data.

The data storage 114 can store outfits, including outfits recommended by the outfit recommendation system 110 and outfits created by users. For example, in addition to generating outfit recommendations, the outfit recommendation system 110 can provide a user interface enabling a user to create outfits using wearable items in the user's possession and/or wearable items available for purchase from clothing retailers. The generated outfits can be stored in association with the user profile of the user who has created the outfit.

The data storage 114 can store style profiles of user in association with user profiles. The style profile of each user can be determined by the outfit recommendation system 110 based on the user's user closet data, outfits created by the user and/or feedback on recommended outfits received from the user.

The data models stored in the data storage 114 and/or the external data storage 108 may include data models helpful for recommending outfits recommendations for the user. The data models can be generated by the outfit recommendation system 110 or by an external system. The data models can be generated using various machine learning techniques for correlating different types of data to assist with the operation of the outfit recommendation system 110.

The user device 104 can include any computing device that is capable of receiving an input from a user and communicating with the outfit recommendation system 110 via the network 102. The user device 104 may communicate with the network 102 through a wired or wireless connection. In some embodiments, the connection request initiated from the user device 104 may be initiated from a mobile application and directed at a mobile application communications application on the outfit recommendation system 110.

The user device 104 can include at least a processor and memory, and may be a smartphone, an electronic tablet device, a personal computer, workstation, server, portable computer, mobile device, personal digital assistant, laptop, an interactive television, video display terminals, gaming consoles, and portable electronic devices or any combination of these. The user device 104 can also include a communication interface that can receive input from various input devices, such as a touch screen, a mouse, a keyboard, a thumbwheel, a track-pad, a track-ball, voice recognition software and the like, depending on the requirements and implementation of the user device 104 and of the outfit recommendation system 110. The communication component of the user device 104 can also include an interface that enables the user device 104 to communicate with the outfit recommendation system 110.

The user device 104 includes or is in communication with a display that can display outfit recommendations and the user's virtual closet. Referring back to FIG. 3, screenshot 300 shows an example graphical user interface (GUI) that shows wearable items 302 in the user's virtual closet. The user can interact with the GUI to add wearable items, for example, by clicking or pressing on the “add wearable items” button 310. The user device 104 can have sufficient processing capabilities to perform image processing tasks. For example, in some embodiments, the user device 104 can process images containing wearable items to extract the wearable items from the images, manipulate the images and/or to annotate the wearable items.

In at least one embodiment, the user device 104 is a terminal that may be placed inside a retail store. In such embodiments, the outfit recommendation system 110 can generate recommendations that include one or more items that may be purchased at the retail store.

The network 102 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between, the outfit recommendation system 110, the user device 104 and the external data storage 108.

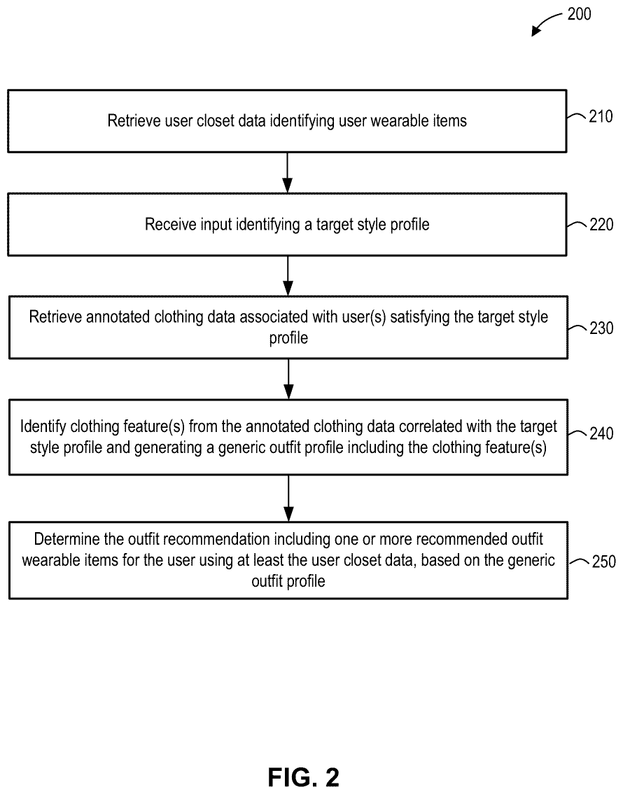

The external data storage 108 can store data similar to that of the data storage 114. For example, the external data storage 108 can store the data models used by the outfit recommendation system 110 and/or information related to, but not limited to, the users of the outfit recommendation system 110. The external data storage 108 can, for example, be a network attached storage (NAS) or a cloud storage. The data stored in the external data storage 108 can be retrieved by the outfit recommendation system 110 via the network 102. In some embodiments, the external data storage 108 can be a data storage operated by a third-party, for example, by a clothing retailer. For example, the external data storage 108 can store wearable items stored by a clothing retailer. In such embodiments, the outfit recommendation system 110 can communicate with multiple external data storages 108 associated with different clothing retailers. As will be explained in further detail with reference to FIG. 2, in some embodiments, the outfit recommendation system 110 can recommend an outfit that includes one or more wearable items available for purchase from a clothing retailer. In some embodiments, the outfit recommendation system 110 can retrieve the wearable items stored in the external data storages 108 associated with the different clothing retailers, process images of the wearable items to generate annotated clothing data and store the annotated clothing data.

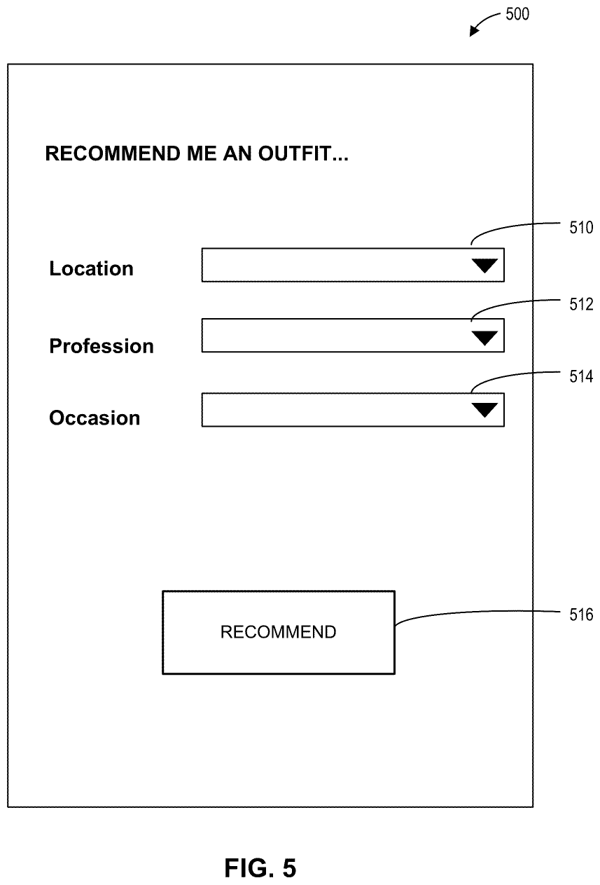

Reference is now made to FIG. 2, which shows a flowchart 200 of an example method of generating an outfit recommendation for a user by the outfit recommendation system 110. The outfit recommendation includes recommended outfit wearable items. The method 200 can be conducted by a processor of the outfit recommendation system 110, such as processor 112 and can be initiated when the user interacts with the user device 104 to transmit a request to the outfit recommendation system 110 to generate an outfit recommendation. For example, the user can interact with a GUI element, such as a button, as shown in FIG. 5, which shows button 516 to request an outfit recommendation.

At 210, the processor 112 retrieves, from a data storage such as the data storage 114 or the external data storage 108, user closet data identifying user wearable items associated with the user. The user closet data can identify wearable items that are in the user's possession, including clothing item the user owns or otherwise has access to (e.g., shared wearable items, wearable items the user can borrow). For example, as explained, the user can be associated with a user profile and the user's wearable items can be stored in association with the user profile. It may be possible for certain user profiles to be linked such that wearable items between those user profiles can be shared—e.g., as between close relatives (e.g., siblings, cousins, etc.), and/or close friends.

Though step 210 is shown as occurring first, step 210 may be performed after any one of steps 220, 230 and 240.

At 220, the processor 112 receives an input from the user device 104 associated with the user for which an outfit recommendation is being generated, identifying a target style profile. The target style profile can correspond to a style the user wishes to adopt. The input can be a selection of a target style profile from a list of available target style profiles. For example, the outfit recommendation system 110 can cause a drop-down menu, a checklist, or other selectable graphical user interface element containing the list of available target style profiles to be displayed on the graphical user interface of the user device 104. Alternatively, in at least one embodiment, the target style profile can be determined based on images uploaded by the user device 104 to the outfit recommendation system 110. For example, the user device 104 may transmit images of inspirational outfits to the outfit recommendation system 110 and the outfit recommendation system 110 can determine the target style profile based on the images.

Referring briefly to FIG. 5, which shows screenshot 500 of the GUI, the target style profile can be selected by selecting from one or more menus, for example a location drop-down menu 510, a profession drop-down menu 512 and an occasion drop-down menu 514.

In some embodiments, the target style profile includes a target location, for example, a target city, region or country. For example, a target style profile identifying “Milan” as the target location can indicate that the user is requesting a recommendation for an outfit that would be worn by individuals living in Milan. For example, the user may be traveling to Milan and seeking to dress like a local.

In some embodiments, the target style profile includes a target profession. For example, a target style profile identifying “lawyer” as the target profession can indicate that the user is requesting a recommendation for an outfit that would be worn by lawyers. For example, the user may be starting a new position as a lawyer and seeking to dress like other lawyers.

In some embodiments, the target style profile can include a target location and a target profession. An example target style profile can be “lawyer in Milan”, indicating that the user is requesting a recommendation for an outfit that would be worn by lawyers in Milan. For example, the user may be lawyer traveling to Milan for business purposes and seek to dress like other lawyers in Milan.

In at least one embodiment, the target style profile additionally includes a target season and/or target weather. For example, the user may wish to obtain a future outfit recommendation. For example, a user located in the northern hemisphere may request an outfit recommendation for a vacation in the southern hemisphere. As another example, a user may request an outfit recommendation for a rainy day, a snowy day, a sunny day, etc. The target season and/or target weather can be specified via a user input from the user device 104. For example, the user device 104 may display a list of seasons and weathers and receive a selection from the user. Alternatively, or in addition thereto, the target season and/or target weather may be determined based on a weather application. For example, the outfit recommendation system 110 may communicate with a weather application (e.g., weather forecast application) to receive the weather for a particular day.

In at least one embodiment, the input includes a calendar, and the target style profile is determined based at least in part on the calendar. For example, the outfit recommendation system 110 can communicate with a calendar stored on the user device 104 or accessible by the user device 104 to determine the user's schedule. Based on the events in the user's calendar, the outfit recommendation system 110 can determine a target style profile for the user. For example, the user's calendar may indicate that the user is traveling to Paris the following week and the outfit recommendation system 110 may determine that the target style profile includes Paris as a target location. As another example, the user's calendar may indicate that the user is attending a local networking event and the outfit recommendation system 110 may determine that the target style profile corresponds to the user's profession and that the user seeks an outfit recommendation that is in accordance with the user's profession. In some embodiments, the outfit recommendation system 110 can determine the target season and/or the target weather based on the calendar. For example, based on a date, the outfit recommendation system 110 can determine the time of the year including the target season. The outfit recommendation system 110 can estimate a target weather based on the date and/or retrieve data from a weather application based on the date.

In some embodiments, the target style profile includes an occasion. An example target style profile that includes an occasion can be “office holiday party”, indicating that the user is requesting a recommendation for an outfit that would be worn at work holiday party.

In some embodiments, the target style profile includes a mood. For example, the outfit recommendation system 110 can request a selection of a mood from the user. An example target style profile that includes a mood can indicate that the user is feeling confident, or wants to look confident.

In some embodiments, the target style profile includes a target entity. For example, the target entity can be a celebrity. In such embodiments, the outfit recommendation system 110 can maintain a list of well-known celebrities and the celebrity can be selected from a list via for example, a drop-down list or any other GUI element that allows the user to make a selection. The list of well-known celebrities can be celebrities for which the outfit recommendation system 110 has sufficient data to generate an outfit in accordance with the celebrity's style. Alternatively, the outfit recommendation system 110 can request one or more images of the celebrity. The user device 104 can transmit the images of the celebrity to the outfit recommendation system 110 and the outfit recommendation system 110 can process the image(s) to identify clothing features of the celebrity.

At 230, the processor 112 retrieves, from the data storage, such as data storage 114 or the external data storage 108 annotated clothing data that is associated with one or more other users satisfying the target style profile. As explained, the data storage can store user closet data in association with a user profile.

The processor 112 can identify one or more users other than the user requesting the outfit recommendation that satisfy the target style profile. For example, if the target style profile indicates “Milan” as the target location, the processor 112 can identify one or more users whose user profile indicates that they reside in Milan. The processor 112 can then retrieve annotated clothing data associated with those users. As another example, if the target style profile includes a target profession, the processor 112 can identify one or more users whose user profile indicates the target procession and the processor 112 can then retrieve annotated clothing data associated with those users. For example, if the target style profile indicates “lawyer” as the target profession, the processor 112 can identify one or more users whose user profile indicates that they are lawyers and retrieve annotated clothing data associated with those users.

By retrieving annotated clothing data that is associated with other user(s) satisfying the target style profile, the outfit recommendation system 110 can generate an outfit recommendation using real data and that more accurately reflects the target style profile. The outfit recommendation system 110 can also continuously improve its recommendations, as more users satisfying the target style profile employ the outfit recommendation system 110 and/or more outfits or user closet data is received from users satisfying the target style profile.

In embodiments where the target style profile identified includes a celebrity, the outfit recommendation system 110 can retrieve annotated clothing data associated with the celebrity. For example, the outfit recommendation system 110 can maintain user profiles for popular celebrities, determine user closet data for the celebrities based on images of the celebrity and annotate the clothing data. As another example, the outfit recommendation system 110 can retrieve images of a celebrity from the celebrity's social media accounts and determine user closet data for the celebrity based on social media images of the celebrity and annotated the clothing data.

At 240, the processor 112 identifies one or more clothing features, from the annotated clothing data retrieved at 230, that are correlated with the target style profile and generates a generic outfit profile that includes the identified clothing feature(s). The processor 112 can analyze the annotated clothing data to identify the clothing feature(s). In some embodiments, the processor 112 can assign weights to clothing features in proportion to their correlation with the target style profile and generate a generic outfit profile that indicates weighting of clothing features. The clothing features can include characteristics of wearable items (e.g., shape, color, pattern, length, fit, cut, neckline, fabric, texture) and/or characteristics of combinations of wearable items (e.g., fit combination, shape combination, color combination, pattern combination, length combination, fabric combination, texture combinations). For example, the processor 112 can identify clothing features that are correlated or most strongly correlated (e.g., that are most commonly associated) with the target style profile and generate a generic outfit profile that includes these clothing features. For example, the processor 112 may determine that there is a strong correlation between straight-legged navy or grey trousers and the target profession “lawyer” and generate a generic outfit profile that includes clothing features including straight-legged navy or grey trousers. As another example, the processor 112 may determine that there is a correlation between a combination of a light-colored top and a dark-colored bottom and the target profession “lawyer” and generate a generic outfit profile that includes clothing features including a combination of light-colored tops and dark-colored bottoms.

The generic outfit profile can include a collection of clothing features identified as being correlated with the target style profile. For example, the generic outfit profile can include a list of clothing features. The list may be a ranked or a weighted list. In some embodiments, the generic outfit profile is encoded as a collection of tensors.

In some embodiments, the outfit recommendation system 110 can employ machine learning techniques for analyzing the annotated clothing data to identify the clothing feature(s) correlated with the target style profile.

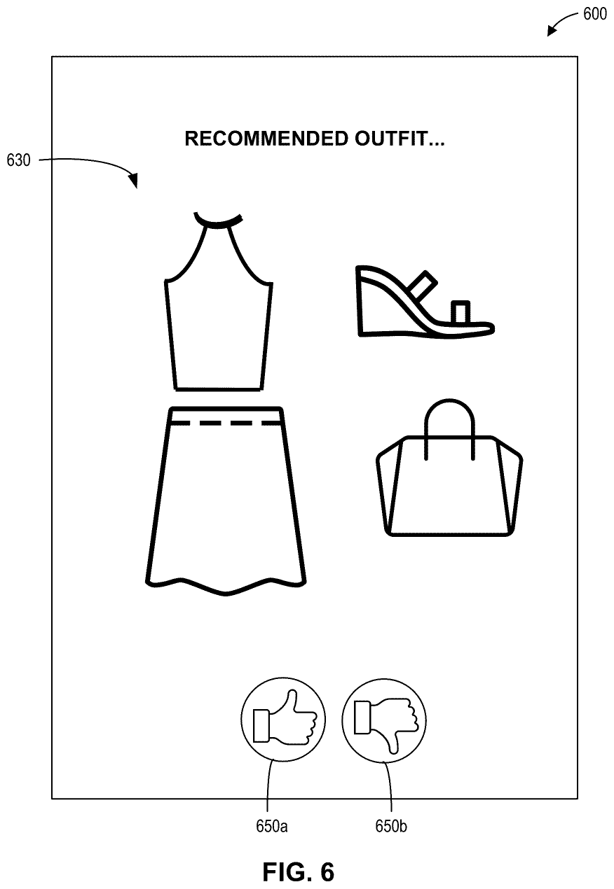

At 250, the processor 112 determines an outfit recommendation for the user based on the generic outfit profile generated at 240. The outfit recommendation for the user includes one or more recommended outfit wearable items and uses at least the user closet data. For example, the outfit recommendation can be a full outfit (e.g., top, bottom, shoes, accessories) or a partial outfit (e.g., top, bottom) that only includes wearable items that are in the user's possession. The outfit recommendation can correspond to an outfit that satisfies the generic outfit profile. For example, if a given generic outfit profile includes the clothing feature “brightly colored top”, the outfit recommendation system 110 may select a brightly colored top from the wearable items associated with the user as a recommended top. As another example, if a given generic outfit profile includes clothing features including a combination of a brightly colored top and a straight, knee-length skirt, the outfit recommendation system 110 may select a brightly colored top and a straight, knee-length skirt from the wearable items associated with the user. The outfit recommendation system 110 can cause an image of the outfit recommendation to be displayed on the user device 104 as shown in screenshot 600 of FIG. 6, which shows recommended outfit 630.

In some embodiments, the processor 112 can determine the outfit recommendation by comparing the generic outfit profile generated at 240 and the user's user closet data. For example, in embodiments where the user's user closet data is expressed as a collection of tensors, the processor 112 can determine an outfit recommendation by minimizing the distance between the generic outfit profile and the user's user closet data. In other embodiments, the processor 112 can employ a machine learning model (e.g., neural network) and the weights (parameters) of the machine learning model can be the tensors defining the generic outfit profile. In such embodiments, the outfit recommendation can correspond to a prediction of the machine learning model using the user's user clothing data as input. The combination of wearable items in the user's virtual closet that most closely match the generic outfit profile according to the clothing features of the wearable items can be determined.

In some embodiments, the processor 112 can determine more than one outfit recommendation. In such cases, the outfit recommendations may be displayed one at a time. For example, a first outfit recommendation may be displayed and the user may interact with the user interface (e.g., by scrolling, by swiping) to display additional outfit recommendations.

In some embodiments, the outfit recommendation can include one or more wearable items that are available for purchase from a clothing retailer (i.e., retailer wearable items), in addition to wearable items that are in the user's possession. For example, the outfit recommendation can include a shirt and a pair of shoes that are in the user's possession and a skirt, or one or more skirt options that can be purchased from a clothing retailer.

In some embodiments where the outfit recommendation includes retailer wearable items, at 230, the other user(s) associated with the annotated clothing data can include retailers. For example, for each retailer, the outfit recommendation system 110 can generate a user profile and the outfit recommendation system 110 can process images of the retailer wearable items associated with each retailer to obtain annotated clothing data.

The outfit recommendation system 110 can determine that one or more wearable items in a recommended outfit are not in the user's possession. In such cases, the outfit recommendation system 110 can retrieve a catalog of retailer wearable items associated with retailers from a data store such as data storage 114 or external data storage 108 and identify one or more retailer wearable items from the catalog as recommended outfit wearable items.

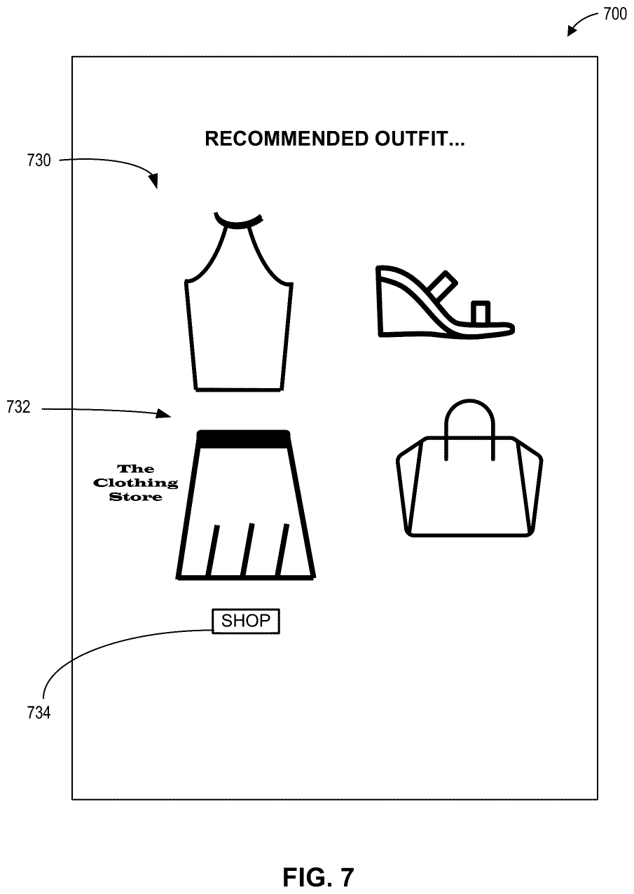

As shown in FIG. 7, which shows a screenshot 700 of a graphical user interface of an example of an application of the outfit recommendation system 100, outfit 730 includes retailer item 732. As shown in FIG. 7, in some embodiments, the graphical user interface can display a “shop” or similar button or other interactable graphical user interface element that can cause the clothing retailer's website to be accessed, allowing the user to purchase the recommend retailer item 732.

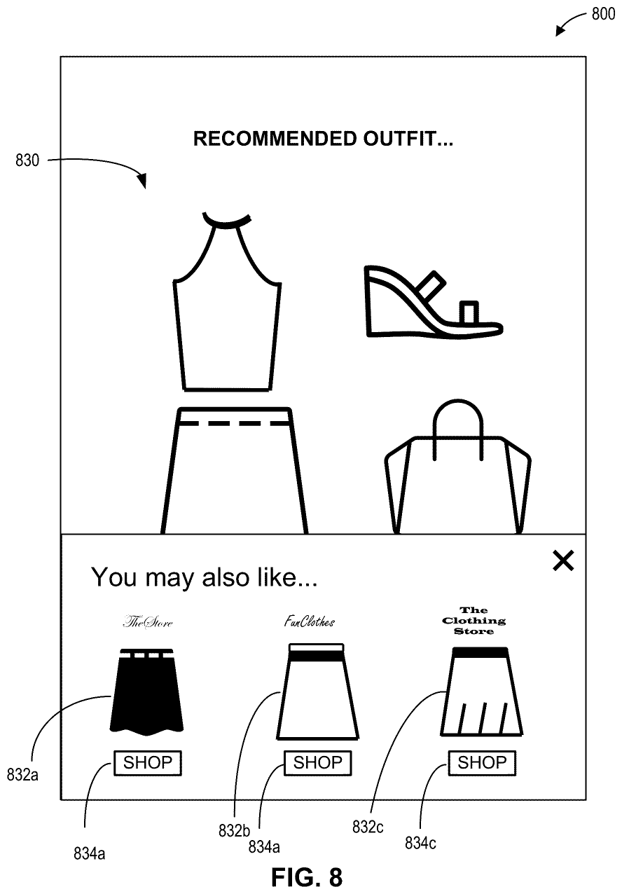

In some embodiments, as shown in screenshot 800 of FIG. 8, which shows recommended outfit 830, additional options 832a-832c may be recommended, and each option may be accompanied by an interactable GUI element that enables the clothing retailer's website to be accessed.

In some embodiments, the outfit recommendation system 110 can select recommended retailers and identify retailer wearable items to recommend from the selected recommended retailers.

In some embodiments, the selected recommended retailers can be selected based on the user's style profile. For example, based on the user's style profile, the outfit recommendation system 110 can determine that the user is likely to purchase wearable items from particular retailers. The selected recommend retailers can correspond for example, to retailers that match the user's style based on the user's style profile and can include retailers from which the user has previously purchased wearable items and/or retailers that fit within the user's budget as determined by the user's clothing data and/or based on a user input indicating a preferred budget. For example, during the onboarding phase or subsequent to the onboarding phase, prior to the user requesting an outfit recommendation, the outfit recommendation system can request a user input indicating a budget for the user.

Alternatively, or in addition to, in some embodiments, the selected recommended retailers can be selected from a group of promoted retailers. The promoted retailers can correspond to retailers sponsoring the outfit recommendation system 110 and/or retailers advertising on the outfit recommendation system 110.

In some embodiments, the inclusion of wearable items from retailers can be optional. For example, the user can opt to exclude outfit recommendations that include retailer wearable items by interacting with the GUI of the outfit recommendation system 110. For example, the GUI may display an interactable GUI element.

In some embodiments, the outfit recommendation is based in part on the user's style profile. In such embodiments, the user profile includes a user style profile, that can be generated based on the user closet data, outfits created by the user and/or feedback on recommended outfits previously received from the user. For example, as explained, in embodiments where the user can create outfits, the outfit recommendation system 110 can identify clothing features associated with the outfits created by the user, identify correlations between the clothing features, and generate a style profile for the user based on the identified clothing features and the identified correlations. In some embodiments, the outfit recommendation system 110 can also identify the frequency at which wearable items in the user's virtual closet are worn and generate a style profile based on the clothing features of the wearable items most frequently worn by the user. As another example, a feedback button can be displayed along outfit recommendations and the outfit recommendation system 110 can receive feedback from the user device 104. As shown in FIG. 6, the feedback button can be “thumbs up” 650a or “thumbs down”650b though it will be understood that the feedback button can be any similar feedback button that can indicate that the user approves of the outfit recommendation. Based on the feedback received, the outfit recommendation system 110 can identify clothing features correlated with the user's approval of the outfit recommendation and generate or update the style profile of the user.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims. Also, in the various user interfaces illustrated in the drawings, it will be understood that the illustrated user interface text and controls are provided as examples only and are not meant to be limiting. Other suitable user interface elements may be possible.

We claim:

1. A method for generating an outfit recommendation including outfit wearable items for a user, the method comprising operating a processor to:
retrieve, from a data storage, user closet data identifying user wearable items associated with the user;
receive, over a network, an input from a user device associated with the user identifying a target style profile;
retrieve, from the data storage, annotated clothing data associated with one or more other users satisfying the target style profile;
identify one or more clothing features from the annotated clothing data correlated with the target style profile and generate a generic outfit profile comprising the one or more clothing features; and
determine the outfit recommendation for the user using at least the user closet data, based on the generic outfit profile, the outfit recommendation including one or more recommended outfit wearable items.

2. The method of claim 1, wherein the target style profile comprises a target location and wherein the method comprises operating the processor to:
generate the generic outfit profile for the target location.

3. The method of claim 1, wherein the target style profile comprises a target profession and wherein the method comprises operating the processor to:
generate the generic outfit profile for the target profession.

4. The method of claim 2, wherein the target style profile further comprises one or more of: a target season and target weather and wherein the method further comprises operating the processor to:
automatically adapt the generic outfit profile according to the target season and/or the target weather.

5. The method of claim 4, wherein the input comprises a calendar and wherein the target season and/or the target weather is determined based at least in part on the calendar.

6. The method of claim 1, wherein the input comprises a calendar and wherein the method further comprises operating the processor to:
identify an event for the user based on the calendar; and
determine the outfit recommendation for the user based on the event.

7. The method of claim 1, wherein annotations of the annotated clothing data relate to one or more of: a mood, an occasion and one or more clothing item categories.

8. The method of claim 1, further comprising operating the processor to:
determine a style profile for the user based at least on the user closet data; and
determine the outfit recommendation for the user based on the style profile for the user.

9. The method of claim 8, further comprising operating the processor to:
receive from the user device, feedback for the outfit recommendation; and
update the style profile for the user based on the feedback.

10. The method of claim 1, further comprising operating the processor to:
determine if the one or more recommended outfit wearable items are present in the user closet data; and
in response to determining that one or more recommended outfit wearable items are not associated with the user closet data, identify one or more retailer wearable items as the one or more recommended outfit wearable items, the one or more retailer wearable items associated with one or more retailers.

11. The method of claim 10, further comprising operating the processor to:
select one or more recommended retailers based on the style profile for the user,
wherein the one or more retailer wearable items are associated with the one or more recommended retailers.

12. The method of claim 10, further comprising operating the processor to:
select one or more recommended retailers from a group of promoted retailers,
wherein the one or more retailer wearable items are associated with the one or more recommended retailers.

13. The method of claim 1, wherein one or more of the one or more other users comprises retail users.

14. The method of claim 1, wherein the target style profile comprises a target entity and wherein the annotated clothing data is obtained by processing one or more images of the target entity to identify wearable items worn by the target entity in the one or more images.

15. A system for generating an outfit recommendation including outfit wearable items for a user, the system comprising:
a data storage storing:
user closet data identifying user wearable items associated with the user;
annotated clothing data associated with one or more other users; and
a processor operable to:
retrieve, from the data storage, the user closet data;
receive, over a network, an input from a user device associated with the user identifying a target style profile;
retrieve, from the data storage, annotated clothing data satisfying the target style profile;
identify one or more clothing features from the annotated clothing data correlated with the target style profile and generate a generic outfit profile comprising the one or more clothing features; and
determine the outfit recommendation for the user using at least the user closet data, based on the generic outfit profile, the outfit recommendation including one or more recommended outfit wearable items.

16. The system of claim 15, wherein the target style profile comprises a target location and wherein the processor is further operable to:
generate the generic outfit profile for the target location.

17. The system of claim 15, wherein the target style profile comprises a target profession and wherein the processor is further operable to:
generate the generic outfit profile for the target profession.

18. The system of claim 16, wherein the target style profile further comprises one or more of: a target season and target weather and wherein the processor is further operable to:
automatically adapt the generic outfit profile according to the target season and/or the target weather.

19. The system of claim 18, wherein the input comprises a calendar and wherein the target season and/or the target weather is determined based at least in part on the calendar.

20. The system of claim 15, wherein the input comprises a calendar and wherein the processor is further operable to:
identify an event for the user based on the calendar; and
determine the outfit recommendation for the user based on the event.

21. The system of claim 15, wherein annotations of the annotated clothing data relate to one or more of: a mood, an occasion and a clothing item category.

22. The system of claim 15, wherein the processor is further operable to:
determine a style profile for the user based at least on the user closet data; and
determine the outfit recommendation for the user based on the style profile for the user.

23. The system of claim 22, wherein the processor is further operable to:
receive from the user device, feedback for the outfit recommendation; and
update the style profile for the user based on the feedback.

24. The system of claim 15, wherein the processor is further operable to:
determine if the one or more recommended outfit wearable items are present in the user closet data; and
in response to determining that one or more recommended outfit wearable items are not associated with the user closet data, identify one or more retailer wearable items as the one or more recommended outfit wearable items, the one or more retailer wearable items associated with one or more retailers.

25. The system of claim 24, wherein the processor is further operable to:
select one or more recommended retailers based on the style profile for the user,
wherein the one or more retailer wearable items are associated with the one or more recommended retailers.

26. The system of claim 24, wherein the processor is operable to:
select one or more recommended retailers from a group of promoted retailers,
wherein the one or more retailer wearable items are associated with the one or more recommended retailers.

27. The system of claim 15, wherein one or more of the one or more other users comprises retail users.

28. The system of claim 15, wherein the target style profile comprises a target entity and wherein the annotated clothing data is obtained by processing one or more images of the target entity to identify wearable items worn by the target entity in the one or more images.
